(19) United States
(12) Patent Application Publication
(10) Pub. No.: US 2021/0115622 A1
(43) Pub. Date: Apr. 22, 2021

(54) HEAT-INSULATING SHEET AND MANUFACTURING METHOD THEREFOR

(71) Applicant: Panasonic Intellectual Property Management Co., Ltd., Osaka (JP)

(72) Inventors: TAKAHIRO YOSHII, Osaka (JP); RIKAKO IWASAKI, Osaka (JP)

(21) Appl. No.: 17/257,680

(22) PCT Filed: Oct. 4, 2019
(86) PCT No.: PCT/JP2019/039323

§ 371 Date: Jan. 4, 2021

(30) Foreign Application Priority Data
Nov. 15, 2018 (JP) 2018-214768
Feb. 21, 2019 (JP) 2019-028980

(51) Int. Cl. D06M 11/79; C01B 33/16; B32B 5/26; B32B 7/05; B32B 7/027

(52) U.S. Cl. CPC D06M 11/79; C01B 33/16; B32B 5/26; B32B 7/05; B32B 7/027; B32B 2457/10; B32B 2260/023; B32B 2307/304; B32B 2262/101; B32B 2305/026; D06M 2400/02

(57) ABSTRACT

Fiber sheets each including internal pores therein are prepared. A fibrous body including the fiber sheets is formed by stacking the fiber sheets and joining the fiber sheets to each other at joining regions. Silica xerogel is put into the internal pores of each of the fiber sheets of the fibrous body by impregnation. The put silica xerogel is hydrophobized while a space is formed between the fiber sheets in a non-joining region between the joining regions of the fibrous body. This method provides a heat-insulating device resistant to a force in surface directions and having a predetermined thickness.

### TECHNICAL FIELD

The present invention relates to a heat-insulating sheet that is used as a heat insulation measure and also relates to a method for manufacturing the heat-insulating sheet.

### BACKGROUND ART

In recent years, there have been demands for energy saving, and insulating a unit from heat provides an improvement in energy efficiency, thus serving as an energy saving method. For such heat insulation, a heat-insulating sheet that provides excellent heat insulation is required. A heat-insulating device including a fiber sheet that supports silica xerogel has a lower thermal conductivity than air, and thus being used to this end. A conventional heat-insulating sheet having such a configuration is disclosed, for example, in PTL 1.

While demand for energy saving recently increases, insulation from heat for a unit is an energy saving method that improves energy efficiency. Heat insulation between plural battery cells installed in a secondary battery is demanded for preventing one hot battery cell from affecting adjacent battery cells. A heat-insulating sheet that provides excellent heat insulation may be provided between the battery cells in a heat insulation measure. A conventional heat-insulating sheet having such an application is disclosed, for example, in PTL 2.

### CITATION LIST

### Patent Literature

PTL 1: Japanese Patent Laid-Open Publication No. 2011-136859

PTL 2: International Publication No. WO 2018/003545

### SUMMARY

Fiber sheets each including internal pores therein are prepared. A fibrous body including the fiber sheets is formed by stacking the fiber sheets and joining the fiber sheets to each other at joining regions. Silica xerogel is put into the internal pores of each of the fiber sheets of the fibrous body by impregnation. The put silica xerogel is hydrophobized while a space is formed between the fiber sheets in a non-joining region between the joining regions of the fibrous body.

This method provides a heat-insulating device resistant to a force in surface directions force and having a predetermined thickness.

Another heat-insulating device includes a first heat insulator and a second heat insulator. The second heat insulator faces a lower surface of the first heat insulator and has ends joined to ends of the first heat insulator at joining regions respectively. The first heat insulator includes a first fiber sheet and a first silica xerogel impregnating the first fiber sheet. The second heat insulator includes a second fiber sheet and a second silica xerogel impregnating the second fiber sheet. The first heat insulator has a compression rate larger than or equal to 15% in response to a pressure of 5 MPa applied to the first heat insulator. The second heat insulator has a compression rate smaller than or equal to 10% in response to a pressure of 5 MPa applied to the second heat insulator. Ends of the first fiber sheet are joined to ends of the second fiber sheet at the joining regions, respectively.

This heat-insulating device prevents a battery cell from affecting another battery cell while the cell is heated and expands.

### BRIEF DESCRIPTION OF THE DRAWINGS

FIG. 1A is a perspective view of a heat-insulating sheet according to Exemplary Embodiment 1.

FIG. 1B is a top plan view of the heat-insulating sheet illustrated in FIG. 1A.

FIG. 1C is a cross-sectional view of the heat-insulating sheet along line 1C-1C illustrated in FIG. 1B.

FIG. 2 is a cross-sectional view of the heat-insulating sheet for illustrating a method for manufacturing the heat-insulating sheet according to Embodiment 1.

FIG. 3 is a perspective view of the heat-insulating sheet for illustrating the method for manufacturing the heat-insulating sheet according to Embodiment 1.

FIG. 4 is a cross-sectional view of the heat-insulating sheet for illustrating the method for manufacturing the heat-insulating sheet according to Embodiment 1.

FIG. 5 is a top plan view of the heat-insulating sheet for illustrating another method for manufacturing the heat-insulating sheet according to Embodiment 1.

FIG. 6A is a top plan view of another heat-insulating sheet according to Embodiment 1.

FIG. 6B is a top plan view of still another heat-insulating sheet according to Embodiment 1.

FIG. 7 is a sectional view of a further heat-insulating sheet according to Embodiment 1.

FIG. 8 is a sectional view of a further heat-insulating sheet according to Embodiment 1.

FIG. 9 is a cross-sectional view of a heat-insulating sheet according to Exemplary Embodiment 2.

FIG. 10 is a perspective view of the heat-insulating sheet according to Embodiment 2.

FIG. 11 is a sectional view of a device according to Embodiment 2.

FIG. 12 is a cross-sectional view of the heat-insulating sheet for illustrating a method for manufacturing the heat-insulating sheet according to Embodiment 2.

FIG. 13 is a cross-sectional view of the heat-insulating sheet for illustrating the method for manufacturing the heat-insulating sheet according to Embodiment 2.

### DESCRIPTION OF EMBODIMENTS

### Exemplary Embodiment 1

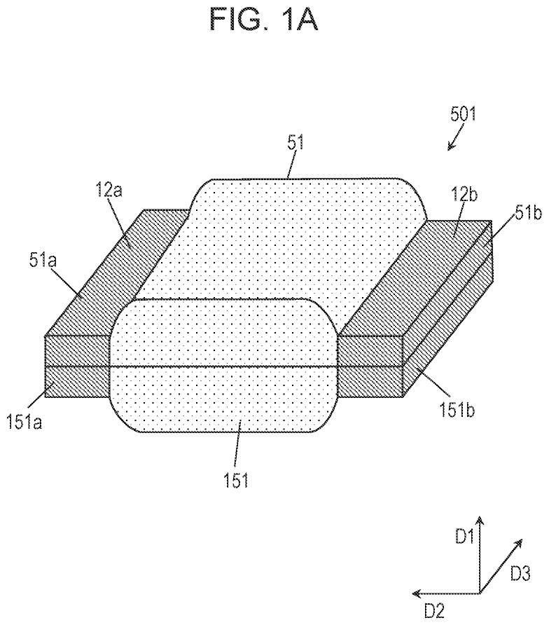

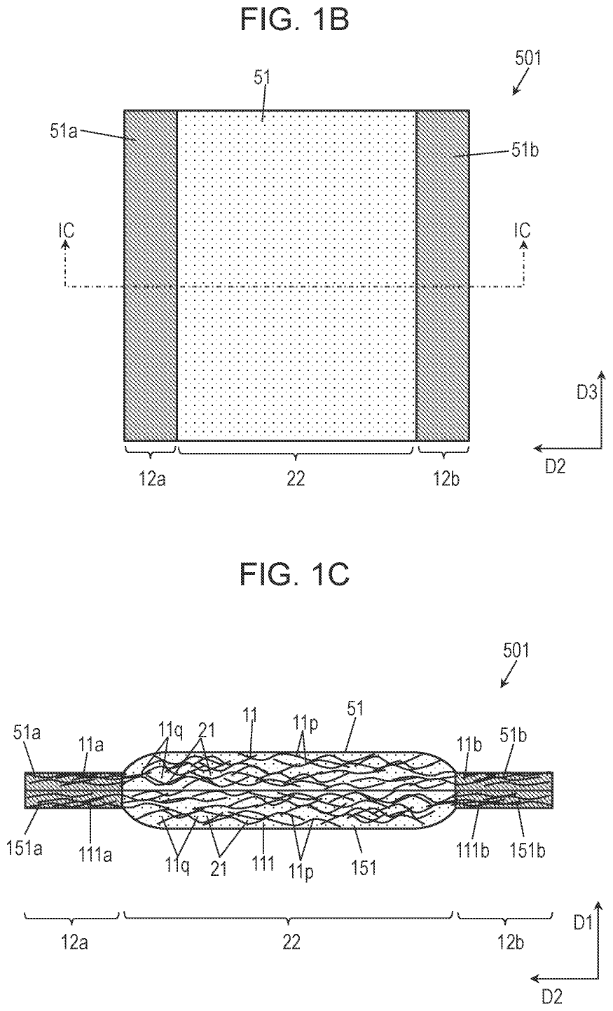

FIGS. 1A and 1B are a perspective view and a top plan view of heat-insulating sheet 501 according to Exemplary Embodiment 1, respectively. FIG. 1C is a cross-sectional view of heat-insulating sheet 501 along line 1C-1C illustrated in FIG. 1B.

Heat-insulating sheet 501 includes heat insulator 51 and heat insulator 151 which has ends 151a and 151b joined to ends 51a and 51b of heat insulator 51 at joining regions 12a and 12b, respectively. Heat insulators 51 and 151 are stacked in stacking direction D1. Ends 51a and 51b are opposite to each other in direction D2 perpendicular to stacking direction D1. Ends 151a and 151b are opposite to each other in direction D2. Therefore, joining regions 12a and 12b are opposite to each other in direction D2.

Heat insulators 51 and 151 have sheet shapes. Heat insulator 51 includes fiber sheet 11 and silica xerogel 21 with which fiber sheet 11 is impregnated. Fiber sheet 11 is made of fibers 11p intertwined with one another to provide internal pore 11q among fibers 11p. Silica xerogel 21 is put into internal pore 11q of fiber sheet 11 by the impregnation. Heat insulator 151 includes fiber sheet 111 and silica xerogel 21 with which fiber sheet 111 is impregnated as well. Fiber sheet 111 is made of fibers 11p intertwined with one another to provide internal pore 11q among fibers 11p. Silica xerogel 21 is put into internal pore 11q of fiber sheet 111 by impregnation.

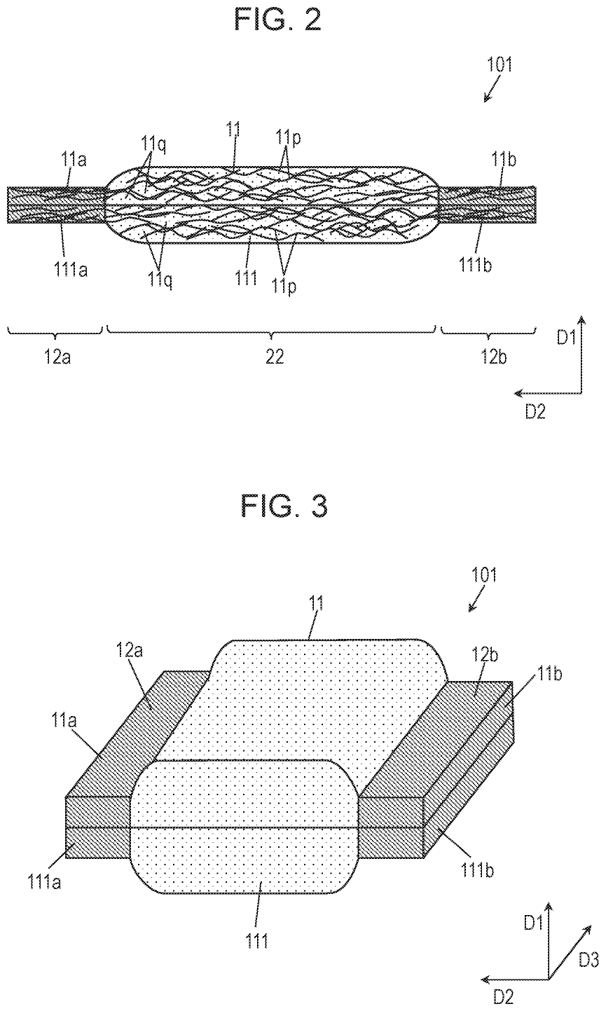

A method for manufacturing heat-insulating sheet 501 will be described below. FIGS. 2 and 3 are a cross-sectional view and a perspective view of heat-insulating sheet 501 for illustrating the method for manufacturing heat-insulating sheet 501, respectively. Fiber sheets 11 and 111 joined to each other at joining regions 12a and 12b constitute fibrous body 101. FIGS. 2 and 3 illustrate fibrous body 101.

Firstly, fiber sheets 11 and 111 each including internal pores 11q are prepared. Fibers 11p composing each fiber sheet 11 and 111 are made of polyethylene terephthalate (hereinafter referred to as PET), and have an average fiber diameter of about 10 μm. A volumetric proportion of internal pores 11q in each fiber sheet 11 and 111 is about 90%. Each of fiber sheet 11 and 111 has a thickness of about 1.5 mm and has a rectangular shape of about 80 mm by 150 mm when viewed in stacking direction D1 (see FIG. 1B).

Next, as illustrated in FIGS. 2 and 3, fiber sheets 11 and 111 are stacked in stacking direction D1 and are joined to each other at joining region 12a and 12b over a width of about 3 mm along sides of each of fiber sheet 11 and 111 extending in direction D3 perpendicular to stacking direction D1 and direction D2, thereby providing fibrous body 101. In the case that fibers 11p are made of thermoplastic resin, such as PET, hot pressing may be employed to weld fiber sheets 11 and 111 to each other at joining regions 12a and 12b. Fibrous body 101 thus obtained has a thickness of about 0.2 mm at joining regions 12a and 12b and a thickness of about 3 mm at non-joining region 22 between joining regions 12. Fiber sheets 11 and 111 are fixedly joined to each other at joining regions 12a and 12b, thus not being displaced. Fiber sheets 11 and 111 can be displaced with respect to each other at non-joining region 22.

In the case that fibers 11p are made of material, such as glass fiber, that does not melt easily, fiber sheets 11 and 111 are hot-pressed while a sheet made of thermoplastic resin, such as PET, is sandwiched between fiber sheets 11 and 111. The sheet has a thickness of about 1 mm and a width of about 3 mm. The hot-pressing causes the sheet to melt. The molten thermoplastic resin is soaked into fiber sheets 11 and 111 to join fiber sheets 11 and 111 to each other. This method allows fibrous body 101 to have a smaller thickness at joining regions 12a and 12b than at non-joining region 22 as well. Three or more fiber sheets 11 may be stacked on one another in stacking direction D1 and joining fiber sheets 11 to one another at joining regions 12a and 12b to similarly provide fibrous body 101.

Next, the impregnation to put silica xerogel 21 into internal pores 11q of fiber sheets 11 and 111 is prepared. A silica sol is prepared by adding concentrated hydrochloric acid that serves as a catalyst to a high-molar silicate aqueous solution that is material of silica xerogel 21. Fibrous body 101 is soaked in this silica sol to allow the silica sol solution to fill internal pores 11q of fiber sheets 11 and 111. Fiber sheets 11 and 111 each having a large proportion of internal pores 11q enables silica xerogel 21 to reach and fill depths of fiber sheets 11 and 111 regardless of the thickness of fiber sheets 11 and 111. Fiber sheets 11 and 111 may be impregnated with silica xerogel 21 by a method, such as dribbling or printing of the silica sol. While being impregnated with the silica sol, fiber sheets 11 and 111 are left for about 15 minutes in order to allow the silica sol to gel. When the gelling of the silica sol is confirmed, fibrous body 101 impregnated with the gelled silica sol is pressed to have a uniform thickness. The uniform thickness may be provided by, e.g. a roll press. Fibrous body 101 having the uniform thickness is put and stored in a thermohygrostat for about three hours in a constant temperature of about 85° C. and a constant humidity of about 85% to grow secondary silica particles for strengthening a gel skeleton structure. This impregnation puts silica xerogel 21 into internal pores 11q of fiber sheets 11 and 111.

Next, silica xerogel 21 put by the impregnation is hydrophobized. Fiber sheets 11 and 111 of fibrous body 101 impregnated with silica xerogel 21 are soaked in 12 N hydrochloric acid for about 1 hour for reaction between the gel and the hydrochloric acid. After that, as a second step of the hydrophobization, fibrous body 101 is soaked in a silylating solution that is mixture of silylating agent and alcohol, and is stored for about 2 hours in a constant temperature bath set at a temperature of about 55° C. This is when the mixture of the silylating agent and the alcohol permeates fibrous body 101. When trimethylsiloxane bonds start forming with progress of reaction, silica treatment progresses. Specifically, the aqueous hydrochloric acid is discharged out of fiber sheet 11 each containing the gel. Following completion of the silylation, the gel is dried for about 2 hours in the constant temperature bath set at a temperature of about 150° C., thereby providing heat-insulating sheet 501 illustrated in FIGS. 1A to 1C.

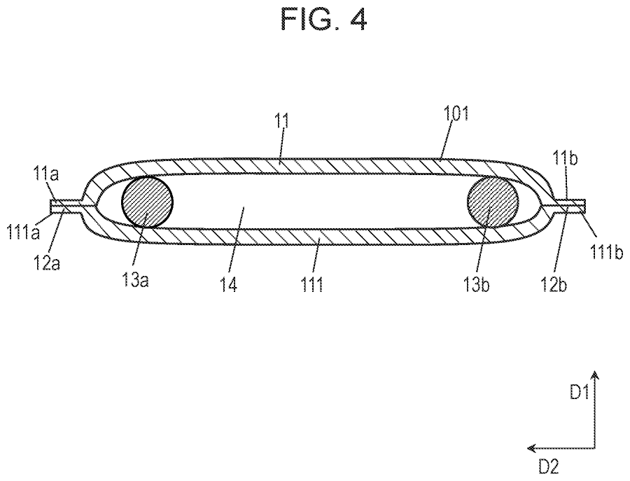

FIG. 4 is a cross-sectional view of heat-insulating sheet 501 for illustrating the method for manufacturing heat-insulating sheet 501 according to Embodiment 1, and particularly illustrates fibrous body 101 undergoing the above-described hydrophobization. In the fiber sheets impregnated with silica xerogel, the internal pores of the fiber sheets are filled with the silica xerogel. Therefore, while the fiber sheets are soaked in solution, such as hydrochloric acid or silylating solution for hydrophobization, the solution does not easily and sufficiently permeate the fiber sheets to reach depths of each of the fiber sheets if each fiber sheet is too thick having, for example, a thickness of more than 2 mm. In contrast, the soak is performed in the exemplary embodiment for the silylation with space 14 provided between fiber sheets 11 and 111 in non-joining region 22 between joining regions 12a and 12b. As shown in FIG. 4, space 14 is formed, for example, by inserting spacers 13a and 13b between fiber sheets 11 and 111 in non-joining region 22. Spacers 13a and 13b are inserted before the hydrophobization. Spacers 13a and 13b has rod shapes and slenderly extend in direction D3 (see FIG. 3). Alternatively, space 14 is formed by locating joining regions 12a and 12b closer to each other so that a distance between joining regions 12a and 12b decreases. Space 14 preferably has a predetermined thickness in stacking direction D1 larger than or equal to one half of the thickness of fiber sheet 11 or 111. In the case that the thickness of the fiber sheet is smaller than or equal to the above predetermined thickness, even if heat-insulating sheet 501 is thick, hydrophobization of entire silica xerogel 21 put into fibrous body 101 by impregnation is achieved. Consequently, heat-insulating sheet 501 is highly reliable. As illustrated in FIG. 1B, heat-insulating sheet 501 has a rectangular shape having two opposite long sides extending in direction D3 and two opposite short sides extending in direction D2. Fiber sheets 11 and 111 have respective ends 11a and 111a joined to each other at joining region 12a that is positioned along one of the two long sides and have their respective ends 11b and 111b joined to each other at joining region 12b that is positioned along the other of the two long sides. This configuration provides heat-insulating sheet 501 with significant resistance to a force in surface directions perpendicular to stacking direction D1. Silica xerogel 21 is, in a broad sense, a xerogel formed from a gel by drying and may be obtained by means of ordinary drying or a method such as supercritical drying or freeze drying. Spacers 13a and 13b are inserted before the hydrophobization.

Upon absorbing moisture, silica xerogel breaks easily. Hydrophobization is necessary to prevent the moisture absorption. On the other hand, a heat-insulating sheet has heat insulation that is proportional to its thickness. Therefore, the heat-insulating sheet accordingly has a large thickness to have significant heat insulation. However, if the fiber sheet is too thick, it is difficult to sufficient hydrophobize the silica xerogel at a middle portion of the fiber sheet, so that the thick sheet may degrade reliability. Accordingly, a required number of heat insulators that have been prepared to each have a predetermined thickness and covered with a protective film are stacked to provide an equivalently thick heat-insulating sheet. However, the heat insulators are not joined to each other, so that this heat-insulating sheet is vulnerable to a force in surface directions.

As described above, heat-insulating sheet 501 according to Embodiment 1 has significant resistance to a force in surface directions perpendicular to stacking direction D1.

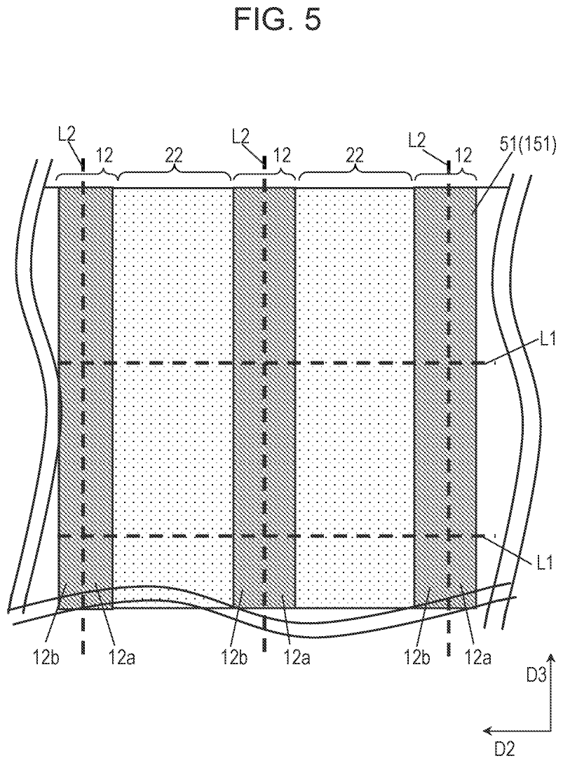

FIG. 5 is a top plan view of heat-insulating sheet 501 for illustrating another method for manufacturing heat-insulating sheet 501 according to Embodiment 1. In the manufacturing method illustrated in FIGS. 2 to 4, individual fiber sheets 11 and 15 have joining regions 12a and 12b, are impregnated with silica xerogel 21, and then, are hydrophobized. In the manufacturing method illustrated in FIG. 5, a large size fiber sheet 11 (111) has plural wide joining regions 12 each having a width of the total of the widths of joining regions 12a and 12b with space 14 (refer to FIG. 4) provided between fiber sheets 11 and 111 in each non-joining region 22 between joining regions 12, silica xerogel 21 is hydrophobized. After that, fiber sheets 11 and 111 (of fibrous body 101) are cut along straight lines L1 extending in direction D2 and along straight lines L2 extending in direction D3, thereby providing plural heat-insulating sheets 501. Each straight line L2 extends through joining region 12 and along joining region 12. Fiber sheets 11 and 111 (of fibrous body 101) are cut along straight line L2 to divide joining region 12 into joining regions 12a and 12b included in heat-insulating sheets 501 adjacent to each other, respectively.

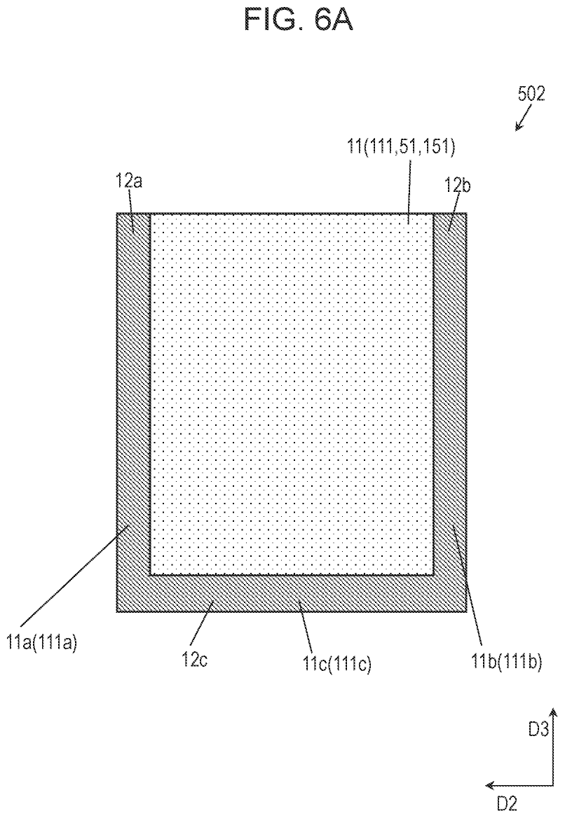

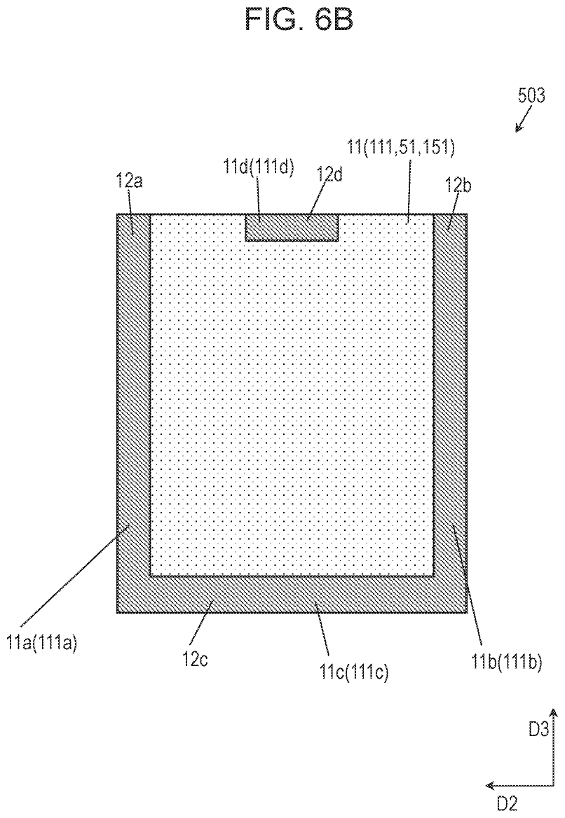

FIG. 6A is a top plan view of another heat-insulating sheet 502 according to Embodiment 1. In FIG. 6A, components identical to those of heat-insulating sheet 501 illustrated in FIGS. 1A to 1C are denoted by the same reference numerals. In addition to joining regions 12a and 12b positioned along two long sides of the rectangular shape of heat-insulating sheet 501, respectively, heat-insulating sheet 502 includes joining region 12c positioned along one short side of two short sides of the rectangular shape. Ends 11c and 111c of fiber sheets 11 and 111 are joined to each other at joining region 12c. Joining region 12c connects joining region 12a to joining region 12b. The other short side of the two short sides of the rectangular shape has no joining region where fiber sheet 11 is not joined to fiber sheet 111. Spacers 13a and 13b are inserted between fiber sheets 11 and 111 from the other short side where none of joining regions 12a, 12b, and 12c are provided to form space 14 for hydrophobization of silica xerogel 21.

FIG. 6B is a top plan view of still another heat-insulating sheet 503 according to Embodiment 1. In FIG. 6B, components identical to those of heat-insulating sheet 502 illustrated in FIG. 6A are denoted by the same reference numerals. In addition to joining regions 12a, 12b, and 12c, heat-insulating sheet 503 includes joining region 12d positioned along one of two short sides of the rectangular shape. Ends 11d, 111d of fiber sheets 11 and 111 are joined to each other at joining region 12d. Joining region 12d is positioned away from joining regions 12a and 12b. At the one of the two short sides, fiber sheet 11 and fiber sheet 111 are not joined to each other between joining region 12d and joining region 12a and between joining region 12d and joining region 12b. Spacer 13a is inserted from between joining region 12d and joining region 12a to be placed between fiber sheets 11 and 111 while spacer 13b is inserted from between joining region 12d and joining region 12b to be placed between fiber sheets 11 and 111, thereby forming space 14 for hydrophobization of silica xerogel 21.

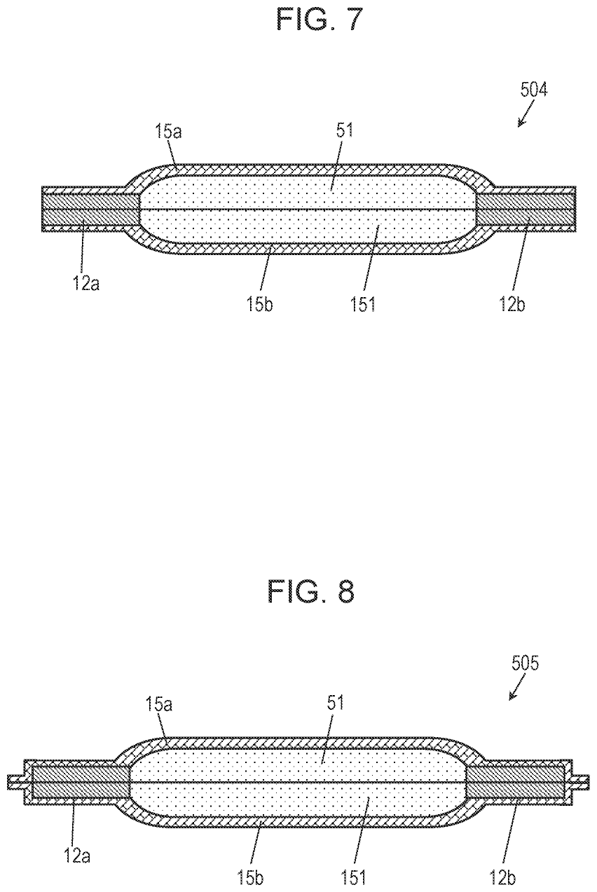

FIG. 7 is a sectional view of further heat-insulating sheet 504 according to Embodiment 1. In FIG. 7, components identical to those of heat-insulating sheet 501 illustrated in FIGS. 1A to 1C are denoted by the same reference numerals. Hydrophobized silica xerogel 21 tends to fall off from surfaces of heat insulators 51 and 151 (fiber sheets 11, 111) in the form of powder. Heat-insulating sheet 504 includes heat insulators 51 and 151 covered with protective films 15a and 15b, respectively. As a thickness of each of the heat insulators increases, a shoulder at each end face of the heat insulator becomes larger. Therefore, if a heat-insulating sheet has no joining regions, a protective film tends to peeled off from the heat insulator with powdery silica xerogel adhering to the protective film. In contrast, heat-insulating sheet 504 according to Embodiment 1 includes protective films 15a and 15b welded or bonded directly to joining regions 12a and 12b respectively at its ends, so that protective films 15a and 15b do not easily peeled off from heat insulators 51 and 151, respectively, consequently improving reliability.

FIG. 8 is a sectional view of further heat-insulating sheet 505 according to Embodiment 1. In FIG. 8, components identical to those of heat-insulating sheet 504 illustrated in FIG. 7 are denoted by the same reference numerals. Heat-insulating sheet 505 includes protective films 15a and 15b joined to each other outward of each of joining regions 12a and 12b. Each of heat insulators 51 and 151 has a smaller thickness at joining regions 12a and 12b than at non-joining region 22, and thus has a smaller shoulder even when heat insulators 51, 151 are thick, consequently improving reliability.

### Exemplary Embodiment 2

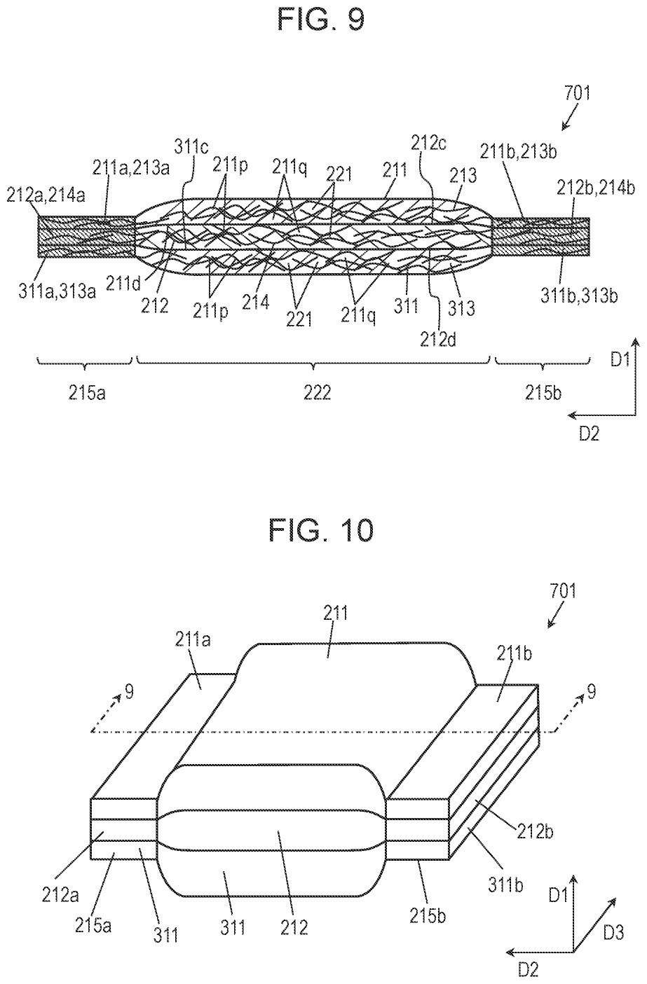

FIG. 9 is a cross-sectional view of heat-insulating sheet 701 according to Exemplary Embodiment 2. FIG. 10 is a perspective view of heat-insulating sheet 701. FIG. 9 illustrates a cross section of heat-insulating sheet 701 along line 9-9 shown in FIG. 10.

Heat-insulating sheet 701 includes heat insulators 211, 212, and 311 that are stacked on one another in stacking direction D1. Heat insulator 212 has lower surface 212d and upper surface 212c that faces lower surface 211d of heat insulator 211. Heat insulator 212 has ends 212a and 212b joined to ends 211a and 211b of heat insulator 211 at joining regions 215a and 215b, respectively. Third heat insulator 311 has upper surface 311c that faces lower surface 212d of heat insulator 212. Heat insulator 311 has ends 311a and 311b joined to ends 212a and 212b of heat insulator 212 at joining regions 215a and 215b, respectively. Ends 211a, 212a, and 311a of heat insulators 211, 212, and 311 are aligned with ends 211b, 212b, and 311b of heat insulators 211, 212, and 311 in direction D2 perpendicular to stacking direction D1, respectively. Heat-insulating sheet 701 has a rectangular shape of about 80 mm by 150 mm. Joining regions 215a and 215b are positioned along two long sides of the rectangular shape, respectively. In accordance with Embodiment 2, each of joining regions 215a and 215b has a width of about 3 mm in direction D2. Heat insulator 211 includes fiber sheet 213 and silica xerogel 221 with which fiber sheet 213 is impregnated. Fiber sheet 213 is made of fibers 211p that are intertwined with one another to have internal pores 211q among fibers 211p. Silica xerogel 221 is put into internal pores 211q of fiber sheet 213 by impregnation. In accordance with Embodiment 2, fiber sheet 213 has a thickness of about 1 mm, and fibers 211p are made of, for example, glass fiber. Heat insulator 212 includes fiber sheet 214 and silica xerogel 221 with which fiber sheet 214 is impregnated. Specifically, fiber sheet 214 is made of fibers 211p that are intertwined with one another to have internal pores 211q among fibers 211p. Silica xerogel 221 is put into internal pores 211q of fiber sheet 214 by the impregnation. In accordance with Embodiment 2, fiber sheet 214 has a thickness of about 1 mm, and fibers 211p are made of glass fiber. Heat insulator 311 includes fiber sheet 313 and silica xerogel 221 with which fiber sheet 313 is impregnated. Specifically, fiber sheet 313 is made of fibers 211p that are intertwined with one another to have internal pores 211q among fibers 211p. Silica xerogel 221 is put into internal pores 211q of fiber sheet 313 by impregnation. In accordance with Embodiment 2, fiber sheet 313 has a thickness of about 1 mm, and fibers 211p are made of, for example, glass fiber.

Each of heat insulators 211 and 311 has a compression rate of about 18% in response to a pressure of 5 MPa applied to heat insulator 211 and 311. Heat insulator 212 has a compression rate of about 8% in response to a pressure of 5 MPa applied to heat insulator 212. The compression rate of each of heat insulator 211 and 311 is thus larger than the compression rate of heat insulator 212 in response to the same pressure applied to heat insulators 211, 212, and 311. Compression rate P1 is expressed as P1=(T0−T1)/T0 with an initial thickness T0 of the heat insulator before the pressure is applied, and a thickness T1 of the heat insulator having the pressure applied thereto. In accordance with Embodiment 2, a value of compression rate P1 is expressed as a percentage.

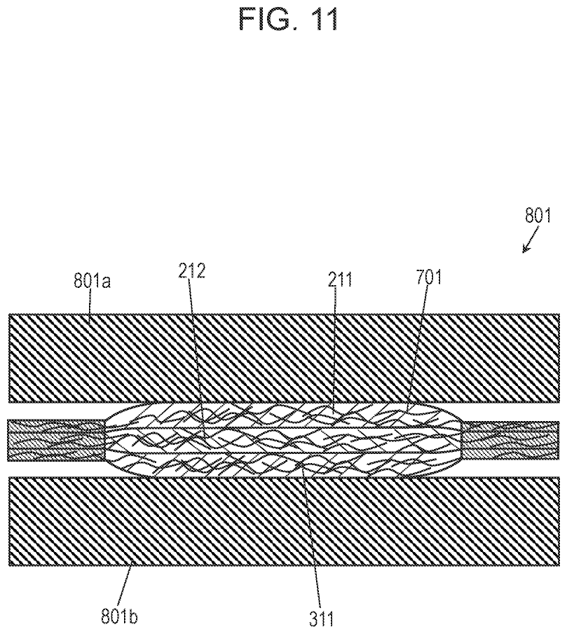

FIG. 11 is a sectional view of device 801 according to Embodiment 2. Device 801 includes battery cells 801a and 801b and heat-insulating sheet 701 disposed between battery cells 801a and 801b. In device 801, a pressure due to expansion of battery cell 801a and 801b is absorbed by heat insulators 211 and 311. In other words, when expanding, battery cell 801a and 801b apply the pressure, and compress heat-insulating sheet 701. In response to this pressure applied to heat insulators 211, 212, and 311, each of heat insulators 211 and 311 has a larger compression rate than heat insulator 212, so that each of heat insulators 211 and 311 is compressed larger than heat insulator 212. The pressure is largely absorbed by heat insulators 211 and 311 and does not significantly affect heat insulator 212. When only single battery cell 801a out of battery cells 801a and 801b becomes hot, heat insulator 212 not being compressed provides heat insulation to prevent another battery cell 801b from being thermally affected.

Heat insulators 211, 212, and 311 are joined to each other preferably while fiber sheets 213, 214, and 313 per se are joined to each other. Heat insulators 211, 212, and 311 having surfaces where silica xerogel 221 is exposed hardly provide high joining strengths. Therefore, fiber sheets 213, 214, and 313 are preferably joined to each other. This configuration eliminates or minimizes a displacement of each heat insulator 211, 212, 311 in surface directions perpendicular to stacking direction D1.

In the case that heat-insulating sheet 701 has a rectangular shape, heat insulators 211, 212, and 311 are preferably joined to one another along at least the two long sides of the rectangular shape. This configuration prevents displacement in surface directions more effectively.

In the case that fiber sheets 213, 214, and 313 are made of thermoplastic resin, such as polyethylene terephthalate (hereinafter referred to as PET), fiber sheets 213, 214, and 313 are joined to one another by heat welding to join heat insulators 211, 212, and 311 to one another. In the case that fiber sheets 213, 214, and 313 are made of material, such as glass fiber, that does not melt easily, in order to join heat insulators 211, 212, and 311 to one another, liquid adhesive is used to join fiber sheets 213, 214, and 313 to one another. Alternatively, sheets made of thermoplastic resin are sandwiched and are heated so that the melted thermoplastic resin fills portions of internal pores 211q of each of fiber sheets 213, 214, and 313 to join fiber sheets 213, 214, and 313 to one another.

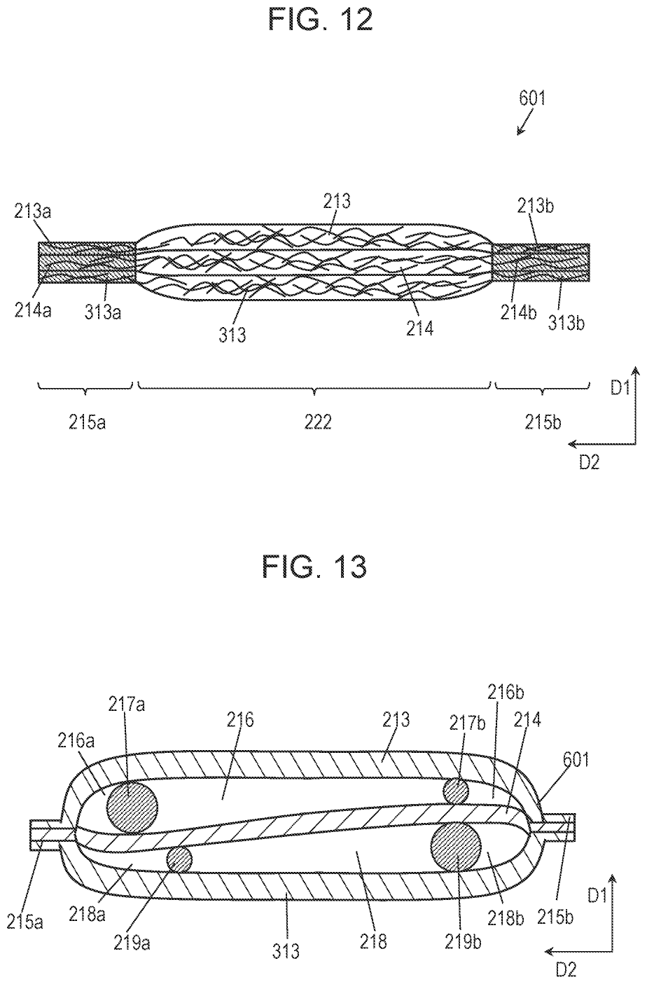

A method for manufacturing heat-insulating sheet 701 according to Embodiment 2 will be described below. FIGS. 12 and 13 are cross-sectional views of heat-insulating sheet 701 for illustrating the method for manufacturing heat-insulating sheet 701.

Fiber sheets 213, 214, and 313 each including internal pores 211q therein are prepared. Each of fiber sheets 213, 214, and 313 has a thickness of about 1 mm, has a rectangular shape of about 80 mm by 150 mm, and is made of fibers 211p with average fiber diameter of about ϕ2 μm that are intertwined with one another. In accordance with Embodiment 2, fibers 211p are made of glass fiber. A grammage per a thickness of 1 mm of each of fiber sheets 213 and 313 is about 127 g/m² while and a grammage per a thickness of 1 mm of fiber sheet 214 is about 180 g/m². The grammage per a thickness of 1 mm of each fiber sheet 213 and 313 is thus smaller than the grammage per a thickness of 1 mm of fiber sheet 214.

Next, fiber sheet 213 is placed on upper surface 214c of fiber sheet 214, fiber sheet 313 is placed on lower surface 214d of fiber sheet 214, and fiber sheets 213, 214, and 313 are joined to one another over a width of about 3 mm along each of the long sides extending in longitudinal direction D3 to define joining regions 215a and 215b, thereby providing fibrous body 601 illustrated in FIG. 12. Fiber sheets 213, 214, and 313 are fixed to one another at joining regions 215a and 215b, and thus are not displaced with respect to one another.

Fiber sheets 213, 214, and 313 are not fixed to one another at non-joining region 222 between joining regions 215a and 215b, and thus can be displaced with respect to one another. A method for joining fiber sheets 213, 214, and 313 to one another includes sandwiching a sheet made of thermoplastic resin, such as PET, and having a thickness of about 1 mm and a width of about 3 mm between ends 213a and 214a of fiber sheets 213 and 214, sandwiching a sheet made of similar plastic resin between ends 213b and 214b of fiber sheets 213 and 214, sandwiching a sheet made of similar plastic resin between ends 214a and 313a of fiber sheets 214 and 313, sandwiching a sheet made of similar plastic resin between ends 214b and 313b of fiber sheets 214 and 313 and performing hot pressing. The melted thermoplastic resin is soaked into fiber sheets 213, 214, and 313 to join fiber sheets 213, 214, 313 to one another.

Next, a preparation is made for the impregnation that puts silica xerogel 221 into internal pores 211q of fiber sheets 213, 214, and 313. A silica sol is prepared by adding a carbonate ester that serves as a catalyst to 20% of water glass that is a material of silica xerogel 221. Fibrous body 601 including fiber sheets 213, 214, and 313 that have been joined to one another is soaked in this silica sol to allow the silica sol solution to fill internal pores 211q of fiber sheets 213, 214, and 313. Fiber sheets 213, 214, and 313 each having a large proportion of internal pores 211q allow the silica sol to reach and fill depths of fiber sheets 213, 214, and 313 regardless of the thicknesses of fiber sheets 213, 214, and 313. While being impregnated with the silica sol, fibrous body 601 is left for about 1 minute in order for the silica sol to gel. When the gelling is confirmed, fibrous body 601 is pressed to have an adjusted uniform thickness. Fibrous body 601 may have a thickness adjusted with, e.g. a roll press. Having been impregnated with the gelled silica sol and having the adjusted thickness, fibrous body 601 is sandwiched between films and is left in an atmosphere for about 1 hour to grow secondary silica particles for strengthening a gel skeleton structure. This impregnation puts silica xerogel 221 into internal pores 211q of fiber sheets 213, 214, and 313.

Next, fiber sheets 213, 214, and 313 of fibrous body 601 impregnated with silica xerogel 221 are rinsed with water for about 30 minutes. After that, silica xerogel 221 is hydrophobized. Fiber sheets 213, 214, and 313 impregnated with silica xerogel 221 are soaked in 6 N hydrochloric acid for about 30 minutes for reaction between gel 221 and the hydrochloric acid. After that, as a second step of the hydrophobization, fibrous body 601 is soaked and stored in silylating solution that is mixture of silylating agent and alcohol for about 2 hours in a constant temperature bath set at a temperature of about 55° C. At this moment, the mixture of the silylating agent and the alcohol permeates fibrous body 601. When trimethylsiloxane bonds start forming with progress of reaction, the aqueous hydrochloric acid is discharged out of fiber sheets 213, 214, and 313 of fibrous body 601 each containing gel 221. Following completion of the silylation, fibrous body 601 is dried for about 2 hours in a he constant temperature bath set at a temperature of about 150° C., thereby providing heat-insulating sheet 701 illustrated in FIG. 9.

While fiber sheets 213, 214, are 313 are soaked in the solution, such as the hydrochloric acid or the silylating solution, for the hydrophobization with internal pores 211q of fiber sheets 213, 214, and 313 filled with the silica xerogel, the hydrophobizing solution does not easily and sufficiently permeate fibrous body 601, particularly fiber sheet 214 to reach depths of fiber sheet 214 if fibrous body 601 is too thick having, for example, an overall thickness of more than 2 mm. In contrast, in accordance with Embodiment 2, the soaking for the silylation involved in the hydrophobization with space 216 formed between fiber sheets 213 and 214 and with space 218 formed between fiber sheets 214 and 313 in non-joining region 222 between joining regions 215a and 215b. In accordance with Embodiment 2, as shown in FIG. 13, spaces 216 and 218 are formed in non-joining region 222 by inserting spacer 217a between fiber sheets 213 and 214 near ends 213a and 214a thereof, inserting spacer 217b between fiber sheets 213 and 214 near ends 213b and 214b thereof, inserting spacer 219a between fiber sheets 214 and 313 near ends 214a and 313a thereof, and inserting spacer 219b between fiber sheets 214 and 313 near ends 214b and 313b thereof. Fibrous body 601 is soaked while spacers 217a, 217b, 219a, and 219b are inserted. Spacers 217a, 217b, 219a, and 219b have rod shapes slenderly extending in direction D3. Alternatively, spaces 216 and 218 may be formed by approaching joining regions 215a and 215b each other with fibrous body 601 is soaked so that a distance between joining regions 215a and 215b becomes smaller. Each of spaces 216 and 218 preferably has a thickness in in stacking direction D1 that is larger than or equal to one half of the thickness of one of fiber sheets 213, 214, and 313. This configuration provides hydrophobization of entire silica xerogel 221, thus providing heat-insulating sheet 701 with high reliability. Since fiber sheets 213, 214, and 313 are joined to one another at joining regions 215a and 215b that are positioned along the two long sides of the rectangular shape, respectively, heat-insulating sheet 701 is resistant to a force in surface directions.

Spacer 217a out of spacers 217a and 217b inserted in space 216 is closer to joining region 215a than spacer 217b is while spacer 217b is closer to joining region 215b than spacer 217a is. Spacer 217a has a larger diameter than spacer 217b. Spacer 219a out of spacers 219a and 219b inserted in space 218 is closer to joining region 215a than spacer 219b is while spacer 219b is closer to joining region 215b than spacer 219a is. Spacer 219a has a smaller diameter than spacer 219b. In other words, portion 216a of space 216 connected to joining region 215a has a larger width in stacking direction D1 than portion 216b of space 216 connected to joining region 215b. Portion 218a of space 218 connected to joining region 215a has a smaller width in stacking direction D1 than portion 218b of space 218 connected to joining region 215b. Portion 216a of space 216 connected to joining region 215a has a larger width in stacking direction D1 than portion 218a of space 218 connected to joining region 215a. Portion 216b of space 216 connected to joining region 215b has a smaller width in stacking direction D1 than portion 218b of space 218 connected to joining region 215b. As described above, the relationship between the diameter sizes of the two spacers inserted in the one of the spaces is reversed in the space adjacent to the one of the spaces to increase the size of each space without preventing fibrous body 601 from having a large overall thickness.

Silica xerogel 221 is, in a broad sense, a xerogel formed from a gel by drying and may be obtained by means of ordinary drying or a method such as supercritical drying or freeze drying.

In accordance with Embodiment 2, the grammage per thickness of 1 mm of each of fiber sheets 213 and 313 is about 127 g/m² while the grammage per thickness of 1 mm of fiber sheet 214 is about 180 g/m². In other words, each of fiber sheets 213 and 313 has the smaller grammage per thickness of 1 mm than fiber sheet 214. As the grammage per thickness of 1 mm becomes smaller, a weight per unit region decreases, and the volumetric proportion of internal pores 211q in the entire fiber sheet increases. Therefore, silica xerogel 221 that is included in a fiber sheet with a smaller grammage has more spaces, providing a larger compression rate in response to a predetermined pressure applied. Accordingly, fiber sheets of different grammages that are stacked and are impregnated simultaneously with silica xerogel 221 provides a heat-insulating device having different compression rates in a thickness direction. In accordance with Embodiment 2, the compression rate of each of heat insulators 211 and 311 is about 18% in response to a pressure of 5 MPa applied to heat insulator 211 and 311, and the compression rate of heat insulator 212 is about 8% in response to a pressure of 5 MPa applied to heat insulator 212. In other words, the compression rate of each of heat insulators 211 and 311 is larger than the compression rate of heat insulator 212 in response to the same given pressure applied to heat insulators 211, 311, and 212. The compression rate of each of heat insulators 211 and 311 larger than or equal to 15% in response to the pressure of 5 MPa applied to each of heat insulator 211 and 311 and the compression rate of heat insulator 212 smaller than or equal to 10% in response to the pressure of 5 MPa applied to heat insulator 212. This configuration allows heat insulators 211 and 311 of heat-insulating sheet 701 disposed between battery cells 801a and 801b of device 801 illustrated in FIG. 11 to absorb a pressure due to expansion of battery cell 801a and 801b. When, for example, single battery cell 801a out of cells 801a and 801b becomes hot, heat insulator 212 not being compressed provides heat insulation to prevent adjacent battery cell 801b from being affected.

At an end of life of a secondary battery, a battery cell has an expanded central portion due to gas produced inside the battery cell. If a heat-insulating sheet having fiber sheets that support a uniformly dense silica xerogel is too firm, the heat-insulating sheet may not fully absorb the expansion of the battery cell while the heat-insulating sheet is compressed and exhibits deteriorated heat insulation if the heat-insulating sheet is too soft. Therefore, one battery cell that has become hot may possibly affect an adjacent battery cell.

When, for example, single battery cell 801a becomes hot in device 801 according to Embodiment 2, as described above, heat insulator 212 not being compressed provides the heat insulation to prevent adjacent battery cell 801b from being affected.

In accordance with Embodiment 2, terms, such as “upper surface” and “lower surface”, indicating directions indicate relative directions determined only by relative position of components, such as the fiber sheets of the heat insulating sheet, and do not indicate absolute directions, such as a vertical direction.

### REFERENCE MARKS IN THE DRAWINGS

11 fiber sheet
12a joining region
12b joining region
13a spacer
13b spacer
14 space
15a protective film
15b protective film
101 fibrous body
111 fiber sheet
211 heat insulator
212 heat insulator
213 fiber sheet
214 fiber sheet
215a joining region
215b joining region
216 space
217a, 217b spacer
218 space
219a, 219b spacer
311 heat insulator
313 fiber sheet
601 fibrous body

1. A method for manufacturing a heat-insulating sheet, comprising:
preparing a plurality of fiber sheets each including internal pores therein;
forming a fibrous body including the plurality of fiber sheets by stacking the plurality of fiber sheets and joining the plurality of fiber sheets to each other at a plurality of joining regions;
putting silica xerogel into the internal pores of each of the plurality of fiber sheets of the fibrous body by impregnation; and
hydrophobizing the put silica xerogel while a space is formed between the plurality of fiber sheets in a non-joining region between the plurality of joining regions of the fibrous body.

2. The method of to claim 1, wherein the heat-insulating sheet has a smaller thickness at the plurality of joining regions than at the non-joining region.

3. The method of claim 1, further comprising providing a spacer between the plurality of fiber sheets of the fibrous body to form the space between the plurality of fiber sheets.

4. The method of claim 3, further comprising removing the spacer from between the plurality of fiber sheets of the fibrous body after said hydrophobizing the put silica xerogel.

5. The method of claim 1, further comprising:
providing two protective films on both surfaces of the fibrous body, respectively; and
covering the fibrous body and the put silica xerogel with the two protective films by joining the two protective films to the plurality of joining regions or by joining the two protective films to each other.

6. A heat-insulating sheet comprising:
a first heat insulator; and
a second heat insulator having an upper surface and ends, the upper surface of the second heat insulator facing a lower surface of the first heat insulator, the ends of the second heat insulator being joined to ends of the first heat insulator at joining regions, respectively, wherein
the first heat insulator includes a first fiber sheet and a first silica xerogel with which the first fiber sheet is impregnated,
the second heat insulator includes a second fiber sheet and a second silica xerogel with which the second fiber sheet is impregnated,
the first heat insulator has a compression rate larger than or equal to 15% in response to a pressure of 5 MPa applied to the first heat insulator,
the second heat insulator has a compression rate of smaller than or equal to 10% in response to a pressure of 5 MPa applied to the second heat insulator, and
ends of the first fiber sheet are joined to ends of the second fiber sheet at the joining regions, respectively.

7. The heat-insulating sheet of claim 6, further comprising
a third heat insulator having an upper surface and ends, the upper surface of the third heat insulator facing a lower surface of the second heat insulator, the ends of the third heat insulator being joined to the ends of the second heat insulator, respectively, wherein
the third heat insulator includes a third fiber sheet and a third silica xerogel with which the third fiber sheet is impregnated,
the third heat insulator has a compression rate larger than or equal to 15% in response to a pressure of 5 MPa applied to the third heat insulator, and
ends of the third fiber sheet are joined to the ends of the second fiber at the joining regions, respectively.

8. The heat-insulating sheet of claim 6, wherein
the heat-insulating sheet has a rectangular shape having two long sides opposite to each other, and
the joining regions are positioned along the two long sides of the rectangular shape of the heat-insulating sheet, respectively.

9. A method for manufacturing a heat-insulating sheet, comprising:
forming a fibrous body including a first fiber sheet having internal pores and a second fiber sheet having internal pores by joining ends of a first fiber sheet to ends of a second fiber sheet at joining regions, respectively;
putting first silica xerogel into the internal pores of the first fiber sheet by impregnation;
putting second silica xerogel into the internal pores of the second fiber sheet by impregnation; and
hydrophobizing the put first silica xerogel and the put second silica xerogel introduced, wherein
the first fiber sheet and the put first silica xerogel constitute a first heat insulator,
the second fiber sheet and the put second silica xerogel constitute a second heat insulator,
the first heat insulator has a compression rate larger than or equal to 15% in response to a pressure of 5 MPa applied to the first heat insulator, and
the second heat insulator has a compression rate smaller than or equal to 10% in response to a pressure of 5 MPa applied to the second heat insulator.

10. The method of claim 9, wherein
the first fiber sheet and the second fiber sheet are made of glass fiber, and
the first fiber sheet has a smaller grammage per a thickness of 1 mm than the second fiber sheet.

11. The method of claim 9, wherein said hydrophobizing the put first silica xerogel and the put second silica xerogel comprises hydrophobizing the put first silica xerogel and the put second silica xerogel while a space is provided between the first fiber sheet and the second fiber sheet in a non-joining region between the joining regions.

12. The method of claim 11, further comprising forming the space between the first fiber sheet and the second fiber sheet by providing a spacer between the first fiber sheet and the second fiber sheet of the fibrous body.

13. The method of claim 12, further comprising removing the spacer from between the first fiber sheet and the second fiber sheet of the fibrous body after said hydrophobizing the put first silica xerogel and the put second silica xerogel.
